(19) United States
(12) Patent Application Publication
(10) Pub. No.: US 2008/0206457 A1
(43) Pub. Date: Aug. 28, 2008

(54) Optical compensatory sheet, polarizing plate and production methods therof

(75) Inventor: Jun Watanabe, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FujiFilm Corporation, Tokyo (JP)

(21) Appl. No.: 12/078,771

(22) Filed: Apr. 4, 2008

Related U.S. Application Data
(62) Division of application No. 11/066,151, filed on Feb. 25, 2005, now abandoned.

(30) Foreign Application Priority Data
Feb. 27, 2004 (JP) 2004-054394

(51) Int. Cl. B05D 5/06

(52) U.S. Cl. 427/163.1; 427/162

(57) ABSTRACT

A method for producing an optical compensatory sheet, which includes: coating a layer comprising a liquid crystalline molecule on a transparent support; aligning the liquid crystalline molecule in an alignment state; fixing the liquid crystalline molecule in the alignment state to form an optically anisotropic layer; and performing a hydrophilization treatment of a surface of the optical compensatory sheet, wherein the hydrophilization treatment is performed under a condition that the optically anisotropic layer satisfies formula (I): (DB−DA)/DB<0.01, wherein DA represents a thickness of the optically anisotropic layer after the hydrophilization treatment; and DB represents a thickness of the optically anisotropic layer before the hydrophilization treatment.

### CROSS-REFERENCE TO RELATED APPLICATIONS

This application is a divisional of U.S. patent application Ser. No. 11/066,151, filed Feb. 25, 2005, the contents of which are herein incorporated by reference, which in turn claims priority to Japanese Patent Application No. 2004-054394, filed Feb. 27, 2004.

### BACKGROUND OF THE INVENTION

1. Technical Field

The present invention relates to an optical compensatory sheet and a polarizing plate, which are used for a liquid crystal display device, and also relates to the production methods thereof.

2. Background Art

Recently, a liquid crystal display device is widely used as a display unit of televisions or personal computers instead of CRT (cathode ray tube), because of its small size, light weight and low consumption of power.

The liquid crystal display device comprises a liquid crystal cell and a polarizing plate. The polarizing plate comprises a protective film and a polarizing layer and this plate is obtained by dyeing a polarizing layer comprising a polyvinyl alcohol film with iodine, stretching the film and stacking a protective film on both surfaces of the film. In a transmission-type liquid crystal display device, this polarizing plate is fixed on both sides of a liquid crystal cell and in some cases, one or more optical compensatory sheet is further disposed. In a reflection-type liquid crystal display device, a reflection plate, a liquid crystal cell, one or more optical compensatory sheet and a polarizing plate are disposed in this order. The liquid crystal cell comprises a liquid crystal molecule, two substrates for encapsulating the liquid crystal molecule, and an electrode layer for applying a voltage to the liquid crystal molecule. The liquid crystal cell displays an ON or OFF mode depending on the difference in alignment state of liquid crystal molecules, and can be applied to all of transmission-type, reflection-type and transflection-type display devices.

As for a display mode according to the alignment state of liquid crystal molecules, display modes such as TN (twisted nematic), IPS (in-plane switching), OCB (optically compensatory bend), VA (vertically aligned), ECB (electrically controlled birefringence), STN (super twisted nematic) have been proposed.

One of the problems of the liquid crystal display device is the viewing angle-dependency of display characteristics and various improvements have been made thereon, such as improvement by the above-described liquid crystal modes or use of an optical compensatory sheet according to respective modes. The optical compensatory sheet is a technique of compensating the optical property generated depending on the alignment state of liquid crystal molecules in the liquid crystal cell, and this can effectively improve the viewing angle-dependency which cannot be controlled by the liquid crystal cell alone.

The optical compensatory sheet has been heretofore produced by using a stretched birefringent polymer film. Instead of the optical compensatory sheet comprising a stretched birefringent film, it is proposed to use an optical compensatory sheet comprising a transparent support having thereon an optically anisotropic layer formed from a low or high molecular liquid crystalline compound. The liquid crystalline compound has various alignment modes and therefore, by using a liquid crystalline compound and performing optical compensation according to the alignment state of liquid crystal molecules in the cell, an optical property unobtainable by conventional stretched birefringent polymer films can be realized.

Regarding such an optical compensatory sheet, a technique of hybrid-aligning a liquid crystalline compound and forming it into a film is known, where the liquid crystalline compound used is a discotic liquid crystalline compound (see, JP-A-6-214116) or a rugby ball-like compound (see, JP-A-10-186356).

When such an optical compensatory sheet is laminated directly with a polarizing layer to work as a protective film of a polarizing plate, a thickness of a liquid crystal display device can be more decreased. The protective film of the polarizing plate, which is not limited to the optical compensatory sheet, is surface-treated for hydrophilization so as to enhance the adhesion to the polarizing layer comprising a polyvinyl alcohol. The hydrophilization treatment may be performed by glow discharge treatment, flame treatment, acid treatment, alkali treatment, ultraviolet irradiation treatment or the like, but an alkali saponification treatment of dipping the protective film in an alkali bath is generally employed.

In this way, the viewing angle characteristics of recent liquid crystal display devices are remarkably enhanced, nevertheless, strong demands for a more widened viewing angle are still increasing. In the technology of improving the viewing angle by using the above-described optical compensatory sheet, it is very difficult to optically compensate the liquid crystal cell completely in all viewing angle directions even with use of an optical compensatory sheet comprising an optically anisotropic layer where a liquid crystalline compound is aligned. In addition to more strict optical characteristics, exact realization of designed characteristics is also very important.

### SUMMARY OF THE INVENTION

An object of the present invention is, in the technology of improving the viewing angle by using an optical compensatory sheet comprising an optically anisotropic layer where a liquid crystalline compound is aligned, to provide an optical compensatory sheet capable of optically compensating a liquid crystal cell completely in all viewing angle directions, ensuring more strict optical characteristics and exactly realizing the designed characteristics, and provide a polarizing plate using the optical compensatory sheet.

Another object of the present invention is to provide production methods of these optical compensatory sheet and polarizing plate.

As a result of intensive investigations, the present inventors have found that optical characteristics are slightly changed on processing a polarizing plate which comprises an optical compensatory sheet, and that this causes a problem in exactly realizing the designed characteristics. Furthermore, it has been found that the thickness of an optically anisotropic layer of the optical compensatory sheet decreases at the saponification treatment of the optical compensatory sheet and this is one of causes of generating change in the optical characteristics. The present invention has been accomplished based on these findings.

According to the present invention, an optical compensatory sheet, an elliptically polarizing plate and production methods thereof, having the following constitutions, are provided, whereby the above-described objects of the present invention are attained.

1. An optical compensatory sheet comprising:

a transparent support; and

an optically anisotropic layer formed by fixing a liquid crystalline molecule in an alignment state,

wherein when the optical compensatory sheet receives a hydrophilization treatment of a surface of the optical compensatory sheet, the optically isotropic layer satisfies formula (I):

(DB−DA)/DB<0.01

wherein DA represents a thickness of the optically anisotropic layer after the hydrophilization treatment; and DB represents a thickness of the optically anisotropic layer before the hydrophilization treatment.

2. The optical compensatory sheet as described in item 1, wherein the hydrophilization treatment is an alkali saponification treatment.

3. The optical compensatory sheet as described in item 1 or 2, wherein the surface of the optical compensatory sheet has a water contact angle of 20° to less than 50° after the hydrophilization treatment.

4. The optical compensatory sheet as described in any one of items 1 to 3, wherein the surface of the optical compensatory sheet has an abundance ratio of a carbon-oxygen single bond after the hydrophilization treatment, and the abundance ratio is larger than that before the hydrophilization treatment.

5. An elliptically polarizing plate comprising:

an optical compensatory sheet described in any one of item 1 to p4;

a polarizing layer of transmitting a light polarized in one direction with respect to an incident light, and a transparent protective sheet in this order.

6. A method for producing an optical compensatory sheet, which comprises:

coating a layer comprising a liquid crystalline molecule on a transparent support;

aligning the liquid crystalline molecule in an alignment state;

fixing the liquid crystalline molecule in the alignment state to form an optically anisotropic layer; and

performing a hydrophilizing treatment of a surface of the optical compensatory sheet,

wherein the hydrophilization treatment is performed under a condition that the optically anisotropic layer satisfies formula (I) described in item 1.

7. The method for producing the optical compensatory sheet as described in item 6, wherein the hydrophilization treatment is an alkali saponification treatment.

8. The method for producing the optical compensatory sheet as described in item 6 or 7, wherein the surface of the optical compensatory sheet has a water contact angle of 20° to less than 50° after the hydrophilization treatment.

9. The method for producing the optical compensatory sheet as described in any one of items 6 to 8 above, wherein the surface of the optical compensatory sheet has an abundance ratio of a carbon-oxygen single bond after the hydrophilization treatment, and the abundance ratio is larger than that before the hydrophilization treatment.

10. A method for producing an elliptically polarizing plate, which comprises stacking an optical compensatory sheet produced by a method described in any one of items 6 to 9, a polarizing layer of transmitting a light polarized in one direction with respect to an incident light, and a transparent protective sheet in this order.

### EFFECTS OF THE INVENTION

By applying the optical compensatory sheet, elliptically polarizing plate and their production methods of the present invention, an optical compensatory sheet and an elliptically polarizing plate both succeeded in obtaining designed viewing angle characteristics and having reliability can be obtained.

### BRIEF DESCRIPTION OF THE DRAWINGS

FIG. 1 is a cross-sectional view roughly showing one example of the optical compensatory sheet and elliptically polarizing plate of the present invention.

FIG. 2 is a view roughly showing the liquid crystal display device produced in Examples.

### DETAILED DESCRIPTION OF THE INVENTION

The constitutions and production methods of the present invention are sequentially described below.

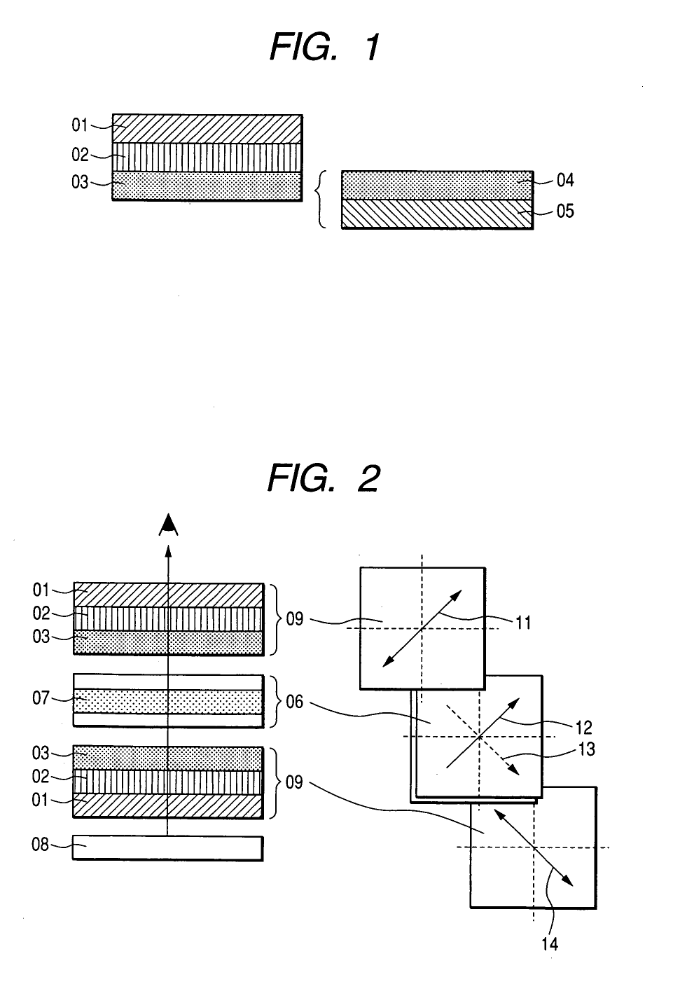

FIG. 1 is a schematic view showing one embodiment of the elliptically polarizing plate (or polarizing plate) of the present invention. The elliptically polarizing plate (or polarizing plate) includes a protective film 01, a polarizing layer 02 and an optical compensatory sheet 03 in this order. The optical compensatory sheet 03 includes a transparent support 04 and an optically anisotropic layer 05, and the polarizing layer 02 is disposed on the transparent support 04 in the elliptically polarizing plate.

The optical compensatory sheet and elliptically polarizing plate for use in the present invention are effective for all liquid crystal display devices including TN mode, VA mode, IPS mode, OCB mode and ECB mode.

### (Optical Compensatory Sheet)

The optical compensatory sheet is obtained by providing an optically anisotropic layer formed from a liquid crystalline molecule (or liquid crystalline compound) on an optically transparent support. When used for a liquid crystal display device, this optical compensatory sheet optically compensates the liquid crystal cell without causing an adverse effect.

The constituent materials necessary for the optical compensatory sheet are described below.

### (Support)

The support for use in the present invention is preferably a glass or a transparent polymer film.

The support preferably has a light transmittance of 80% or more. Examples of the polymer constituting the polymer film as the support include cellulose esters (e.g., mono-, di- or tri-acylate form of cellulose), norbornene polymers and polymethyl methacrylates. Also, commercially available polymers (as the norbornene polymer, ARTON and ZEONEX, both a trade name) may be used. Furthermore, even polymers conventionally known to readily express birefringence, such as polycarbonate and polysulfone, can be used for the optical film of the present invention if the molecule is modified to control the expression of birefringence as described in WO'00/26705.

Among these, cellulose esters are preferred and lower fatty acid esters of cellulose are more preferred. The lower fatty acid means a fatty acid having 6 or less carbon atoms. In particular, cellulose acylates having from 2 to 4 carbon atoms are preferred and a cellulose acetate is more preferred. A mixed fatty acid ester such as cellulose acetate propionate and cellulose acetate butyrate may also be used.

The viscosity average polymerization degree (DP) of cellulose acetate is preferably 250 or more, more preferably 290 or more. Furthermore, the cellulose acetate preferably has a narrow molecular weight distribution represented by Mw/Mn (Mw is a weight average molecular weight and Mn is a number average molecular weight), as measured by gel permeation chromatography. Specifically, the Mw/Mn value is preferably from 1.0 to 1.7, more preferably from 1.0 to 1.65.

For the polymer film, a cellulose acetate having an acetylation degree of 55.0 to 62.5% is preferably used. The acetylation degree is more preferably from 57.0 to 62.0%.

The acetylation degree means an amount of acetic acid bonded per unit weight of cellulose. The acetylation degree can be determined according to the measurement and calculation of acetylation degree described in ASTM: D-817-91 (test method of cellulose acetate, etc.).

In the cellulose acetate, the hydroxyls at the 2-, 3- and 6-positions of cellulose are not evenly substituted but the substitution degree at the 6-position tends to be small. In the polymer film for use in the present invention, the substitution degree at the 6-position of cellulose is preferably equal to or larger than that at the 2-position or 3-position.

The ratio of the substitution degree at the 6-position to the total of substitution degrees at the 2-, 3- and 6-positions is preferably from 30 to 40%, more preferably from 31 to 40%, and most preferably from 32 to 40%. The substitution degree at the 6-position is preferably 0.88 or more.

Specific examples of the acyl group and the synthetic method of cellulose acylate are described in detail in JIII Journal of Technical Disclosure, No. 2001-1745, page 9, Japan Institute of Invention and Innovation (Mar. 15, 2001).

In the case of using a polymer film for the optical compensatory sheet, the polymer film preferably has a desired retardation value.

The preferred range of the retardation value of the polymer film varies depending on the liquid crystal cell for which the optical compensatory sheet is used or depending on the use method of the polymer film, but it is preferred to adjust a Re retardation value to the range from 0 to 200 nm and a Rth retardation value to the range from 70 to 400 nm. The Re retardation value is a retardation value in a film plane of the polymer film, and the Rth retardation value is a retardation value in thickness direction of the polymer film (i.e., a direction perpendicular to the film plane).

In the case of using two optically anisotropic layers for the liquid crystal display device, the Rth retardation value of the polymer film is preferably from 70 to 250 nm. In the case of using one optically anisotropic layer for the liquid crystal display device, the Rth retardation value of the support is preferably from 150 to 400 nm. The birefringent index (Δn: nx−ny) of the polymer film is preferably from 0.00028 to 0.020. Also, the birefringent index {(nx+ny)/2−nz} of the cellulose acetate film in the thickness direction is preferably from 0.001 to 0.04.

The retardation of the polymer film is generally adjusted by applying an external force such as stretching, but depending on the case, a retardation increasing agent for controlling the optical anisotropy may be added. In order to adjust the retardation of the cellulose acylate film by using a retardation increasing agent, an aromatic compound having at least two aromatic rings is preferably used as the retardation increasing agent. The aromatic compound is preferably used in an amount of 0.01 to 20 parts by weight per 100 parts by weight of cellulose acylate. Also, two or more aromatic compounds may be used in combination. The aromatic ring of the aromatic compound includes not only an aromatic hydrocarbon ring but also an aromatic heterocyclic ring. Examples thereof include the compounds described in EP 0911656 A2, JP-A-2000-111914 and JP-A-2000-275434.

The cellulose acetate film for use in the optical compensatory sheet of the present invention preferably has a hygroscopic expansion coefficient of 30×10⁻⁵/% RH or less, more preferably 15×10⁻⁵/% RH or less, still more preferably 10×10⁻⁵/% RH or less. The hygroscopic expansion coefficient is preferably smaller but is usually 1.0×10⁻⁵/% RH or more.

The hygroscopic expansion coefficient represents the variation in the length of a sample when the relative humidity is changed at a constant temperature.

By controlling this hygroscopic expansion coefficient, the optical compensatory sheet can be prevented from frame-like increase of transmittance (light leakage due to strain) while maintaining the optical compensatory function.

The method for measuring the hygroscopic expansion coefficient is described below. A specimen with a width of 5 mm and a length of 20 mm is cut out from the produced polymer film and in the state of one end being fixed, suspended in an atmosphere of 25° C. and 20% RH (RO). A weight of 0.5 g is hung at another end and after the specimen is left standing for 10 minutes, the length (L0) is measured. Thereafter, while keeping the temperature at 25° C., the humidity is changed to 80% RH (R1) and the length (L1) is measured. The hygroscopic expansion coefficient is calculated according to the following formula. The measurement is performed on 10 samples for the same specimen and an average value is employed.

Hygroscopic expansion coefficient (/% RH)={L1−L0)/L0}/(R1−R0)

In order to reduce the dimensional change due to moisture absorption of the polymer film, a compound having a hydrophobic group, a fine particle or the like is preferably added. The compound having a hydrophobic group is preferably an appropriate material selected from plasticizers and deterioration inhibitors having a hydrophobic group such as aliphatic group or aromatic group within the molecule. The amount of such a compound added is preferably from 0.01 to 10 weight% based on the solution (dope) prepared.

Also, the dimensional change due to moisture absorption of the polymer film may be reduced by decreasing the free volume in the polymer film. More specifically, as the residual solvent amount at the film formation by a solvent casting method which is described later is smaller, the free volume is more decreased. The drying is preferably performed under the conditions of giving a residual solvent amount of 0.01 to 1.00 weight % based on the cellulose acetate film.

These additives added to the polymer film or additives which can be added according to various purposes (for example, ultraviolet inhibitor, releasing agent, antistatic agent, deterioration inhibitor (e.g., antioxidant, peroxide decomposing agent, radical inhibitor, metal inactivating agent, acid scavenger, amine) and infrared absorbent) may be a solid or an oily product. In the case of constituting the film by multiple layers, the kind and amount added of the additive may be different among respective layers. Preferred examples of these additives include the materials described in detail in JIII Journal of Technical Disclosure, supra, No. 2001-1745, pp. 16-22. The amount of the additive used is not particularly limited as long as its function can be expressed, but the additive is preferably used in an appropriate amount in the range from 0.001 to 25 weight % based on the entire composition of the polymer film.

### (Production Method of Polymer Film)

The polymer film is preferably produced by a solvent casting method. In the solvent casting method, the film is produced with use of a solution (dope) obtained by dissolving a polymer material in an organic solvent.

The dope is cast on a drum or a band and the solvent is evaporated to form a film. The dope before casting is preferably adjusted to a concentration of giving a solid content of 18 to 35%. The surface of the drum or band is preferably finished to provide a mirror state.

The dope is preferably cast on a drum or band having a surface temperature of 10° C. or less. After the casting, the dope is preferably dried with air for 2 seconds or more. The obtained film is peeled off from the drum or band and the film may be further dried with hot air by sequentially varying the temperature from 100° C. to 160° C. to distil out the residual solvent. This method is described in JP-B-5-17844. According to this method, the time from casting until peeling can be shortened. For practicing this method, it is necessary that the dope is gelled at the surface temperature of the drum or band on casting.

In the casting step, one cellulose acylate solution may be cast as a single layer or two or more cellulose acylate solutions may be co-cast simultaneously or sequentially.

Examples of the method for co-casting two or more multiple layers of the cellulose acylate solution include a method where respective cellulose acylate-containing solution are cast from multiple casting ports provided with spacing in the travelling direction of the support and thereby stacked (for example, the method described in JP-A-11-198285), a method of casting cellulose acylate solutions from two casting ports (for example, the method described in JP-A-6-134933), and a method where a flow of a high-viscosity cellulose acylate solution is wrapped with a low-viscosity cellulose acylate solution and the high-viscosity and low-viscosity cellulose acylate solutions are simultaneously extruded (for example, the method described in JP-A-56-162617), but the present invention is not limited thereto.

The production process by such a solvent casting method is described in detail in JIII Journal of Technical Disclosure, supra, No. 2001-1745, pp. 22-30 where the process is classified into dissolution, casting (including co-casting), metal support, drying, separation, stretching and the like.

The thickness of the polymer film for use in the present invention is preferably from 15 to 120 μm, more preferably from 30 to 80 μm.

### (Surface Treatment of Polymer Film)

The polymer film is preferably surface-treated to enhance the adhesion to an optically anisotropic layer or alignment film which are described later. The surface treatment includes a corona discharge treatment, a glow discharge treatment, a flame treatment, an acid treatment, an alkali treatment and an ultraviolet irradiation treatment. These are described in detail in JIII Journal of Technical Disclosure, supra, No. 2001-1745, pp. 30-32. Among these, an alkali saponification treatment is preferred and this is very effective as the surface treatment of the cellulose acylate film.

The alkali saponification treatment may be performed, for example, by the dipping in a saponification solution or coating with a saponification coating, but the coating method is preferred. Examples of the coating method include a dip coating method, a curtain coating method, an extrusion coating method, a bar coating method and an extrusion slide coating method. Examples of the alkali saponification solution include a potassium hydroxide solution and a sodium hydroxide solution. The normality of hydroxide ion is preferably from 0.1 to 3.0 N. In particular, when the alkali treating solution contains a solvent (e.g., isopropyl alcohol, n-butanol, methanol, ethanol) having good wettability to film, a surfactant and a wetting agent (e.g., diols, glycerin), the saponification solution is enhanced in the wettability to the transparent support (polymer film), the aging stability and the like. Specific examples thereof include those described in JP-A-2002-82226 and WO02/46809.

In addition to the surface treatment, an undercoat layer (described, for example, in JP-A-7-333433) may be provided. Alternatively, the adhesion to the optically anisotropic layer or alignment film may be enhanced by providing an undercoat layer instead of the surface treatment. Examples of embodiments of the undercoat layer include those by a single layer method of coating only one resin layer such as gelatin containing both a hydrophobic group and a hydrophilic group, or by a so-called multilayer method of providing, as a first layer, a layer having good adhesion to the polymer film and then coating thereon, as a second layer, a hydrophilic resin layer such as gelatin having good adhesion to the alignment film (see, for example, JP-A-11-248940).

### (Optically Anisotropic Layer)

A preferred embodiment of the optically anisotropic layer comprising a liquid crystalline compound (liquid crystalline molecule) is described in detail.

The optically anisotropic layer is preferably designed to compensate the liquid crystal compound in the liquid crystal cell at the black display time of a liquid crystal display device. The alignment state of the liquid crystal compound in the liquid crystal cell at the black display time varies depending on the mode of the liquid crystal display device. The alignment state of the liquid crystal compound in the liquid crystal cell is described in IDW′ 00, FMC7-2, pp. 411-414.

Between the thus surface-treated polymer substrate and the optically anisotropic layer provided thereon, an alignment film is preferably disposed.

### (Alignment Film)

The alignment film (or orientation film) has a function of regulating the alignment direction of liquid crystal molecules and therefore, the alignment film is necessary for realizing a preferred embodiment of the present invention. However, once the liquid crystalline compound is aligned and fixed in an alignment state, the alignment film has fulfilled its role and therefore, is not necessarily essential as the constituent element of the present invention. In other words, only the optically anisotropic layer with a fixed alignment state on the alignment film may be transferred onto a polarizing layer to produce the polarizing plate of the present invention.

The alignment film can be provided by a method such as rubbing of an organic compound (preferably polymer), oblique vapor-deposition of an inorganic compound, formation of a layer having microgrooves, or accumulation of an organic compound (e.g., ω-tricosanoic acid, dioctadecyl methylammonium chloride, methyl stearate) according to a Langmuir-Blodgett method (LB membrane). Furthermore, an alignment film of expressing the alignment function upon application of an electric or magnetic field or irradiation of light is also known.

The alignment film is preferably formed by the rubbing of a polymer (alignment film polymer). The polymer used for the alignment film has in principle a molecular structure having a function of aligning liquid crystalline molecules.

In the present invention, in addition to the function of aligning liquid crystalline molecules, a side chain having a crosslinking functional group (e.g., double bond) is preferably bonded to the main chain or a crosslinking functional group having a function of aligning liquid crystalline molecules is preferably introduced into the side chain.

The polymer used for the alignment film may be a polymer which is crosslinkable by itself, or a polymer which is crosslinked with use of a crosslinking agent. Also, a combination thereof may be used.

Examples of the polymer include methacrylate copolymers, styrene copolymers, polyolefins, polyvinyl alcohols, modified polyvinyl alcohols, poly(N-methylolacrylamides), polyesters, polyimides, vinyl acetate copolymers, carboxymethyl cellulose and polycarbonates described, for example, in JP-A-8-338913 (paragraph (0022)). A silane coupling agent can also be used as the polymer. Among these, preferred are water-soluble polymers (e.g., poly(N-methylolacrylamide), carboxymethyl cellulose, gelatin, polyvinyl alcohol, modified polyvinyl alcohol), more preferred are gelatin, polyvinyl alcohols and modified polyvinyl alcohols, and most preferred are polyvinyl alcohols and modified polyvinyl alcohols. It is particularly preferred to use two or more polyvinyl alcohols or modified polyvinyl alcohols differing in the polymerization degree in combination.

The saponification degree of the polyvinyl alcohol is preferably from 70 to 100%, more preferably from 80 to 100%. The polymerization degree of the polyvinyl alcohol is preferably from 100 to 5,000. The side chain having a function of aligning liquid crystal molecules generally has a hydrophobic group as the functional group. The specific kind of the functional group is determined according to the kind of liquid crystal molecule and the desired alignment state.

For example, the modifying group of the modified polyvinyl alcohol can be introduced by modification through copolymerization, chain transfer or block polymerization. Examples of the modifying group include a hydrophilic group (e.g., carboxylic acid group, sulfonic acid group, phosphonic acid group, amino group, ammonium group, amide group, thiol group), a hydrocarbon group having from 10 to 100 carbon atoms, a fluorine atom-substituted hydrocarbon group, a thioether group, a polymerizable group (e.g., unsaturated polymerizable group, epoxy group, aziridinyl group), and an alkoxysilyl group (e.g., trialkoxy, dialkoxy, monoalkoxy). Specific examples of the modified polyvinyl alcohol compound include those described in JP-A-2000-155216 (paragraphs (0022) to (0145)) and JP-A-2002-62426 (paragraphs (0018) to (0022)).

When the side chain having a crosslinking functional group is bonded to the main chain of the alignment film polymer or a crosslinking functional group is introduced to the side chain having a function of aligning liquid crystalline molecules, the alignment film polymer and the polyfunctional monomer contained in the optically anisotropic layer can be copolymerized, as a result, strong bonding by a covalent bond can be produced not only between a polyfunctional monomer and a polyfunctional monomer but also between alignment film polymers and between a polyfunctional monomer and an alignment film polymer. Accordingly, the strength of the optical compensatory sheet can be remarkably enhanced by introducing a crosslinking functional group into the alignment film polymer.

The crosslinking functional group of the alignment film polymer preferably contains a polymerizable group similarly to the polyfunctional monomer. Specific examples thereof include those described in JP-A-2000-155216 (paragraphs (0080) to (0100)).

The alignment film polymer may also be crosslinked by using a crosslinking agent separately from the above-described crosslinking functional group.

Examples of the crosslinking agent include aldehydes, N-methylol compounds, dioxane derivatives, compounds which are caused to act when the carboxylic group is activated, active vinyl compounds, active halogen compounds, isoxazoles and dialdehyde starch. These crosslinking agents may be used in combination of two or more thereof. Specific examples of the crosslinking agent include the compounds described in JP-A-2002-62426 (paragraphs (0023) to (0024)). In particular, aldehydes having high reaction activity are preferred and glutaraldehyde is more preferred.

The amount of the crosslinking agent added is preferably from 0.1 to 20 weight %, more preferably from 0.5 to 15 weight %, based on the polymer. The amount of the non-reacted crosslinking agent remaining in the alignment film is preferably 1.0 weight % or less, more preferably 0.5 weight % or less. By such adjustment, the alignment film can have a sufficiently high durability free from reticulation even when used in a liquid crystal display device for a long period of time or left standing under high-temperature high-humidity conditions for a long period of time.

The alignment film can be fundamentally formed by applying a coating solution containing materials for forming the alignment film, that is, the above-described polymer and crosslinking agent, on a transparent support, drying it under heat (causing crosslinking) and rubbing the film formed. As described above, the crosslinking reaction can be performed at an arbitrary time after applying the coating solution on the transparent support. In the case where a water-soluble polymer such as polyvinyl alcohol is used as the material for forming the alignment film, the coating solution is preferably prepared by using a mixed solvent of water and an organic solvent having defoaming activity (e.g., methanol). The ratio by weight of water to methanol (water:methanol) is preferably from 0:100 to 99:1, more preferably from 0:100 to 91:9. With this ratio, the generation of bubbles can be prevented and the defects on the alignment film and in turn on the surface of the optically anisotropic layer can be greatly decreased.

The alignment film is preferably coated by a spin coating method, a dip coating method, a curtain coating method, an extrusion coating method, a rod coating method or a roll coating method. In particular, a rod coating method is preferred. The thickness of the alignment film after drying is preferably from 0.1 to 10 μm. The drying under heat can be performed at 20 to 110° C. For satisfactorily forming the crosslinking, the temperature at the drying under heat is preferably from 60 to 100° C., more preferably from 80 to 100° C. The drying time may be from 1 minute to 36 hours but is preferably from 1 minute to 30 minutes. The pH is also preferably adjusted to an optimal value for the crosslinking agent used. In the case of using glutaraldehyde, the pH is preferably from 4.5 to 5.5, more preferably 5.

The alignment film is provided on the transparent support or on the undercoat layer. The alignment film can be obtained, as described above, by crosslinking the polymer layer and rubbing the surface thereof.

The rubbing treatment can be performed by a treating method widely employed in the liquid crystal-aligning step of LCD. More specifically, the surface of the alignment film is rubbed with paper, gauze, felt, rubber, or nylon or polyester fiber in the fixed direction, whereby the alignment can be obtained. Generally, the rubbing is performed several times by using, for example, a cloth in which fibers uniform in the length and thickness are averagely implanted.

The alignment film is then caused to function to align liquid crystalline molecules of the optically anisotropic layer provided on the alignment film. Thereafter, if desired, the alignment film polymer is reacted with the polyfunctional monomer contained in the optically anisotropic layer or the alignment film polymer is crosslinked by using a crosslinking agent.

The thickness of the alignment film is preferably from 0.1 to 10 μm.

The liquid crystalline molecule for use in the optically anisotropic layer includes a rod-like liquid crystalline molecule and a discotic liquid crystalline molecule. The rod-like liquid crystalline molecule and discotic liquid crystalline molecule each may be a high molecular liquid crystal or a low molecular liquid crystal and also includes a low molecular liquid crystal which is crosslinked and does not exhibit the liquid crystallinity any more.

### (Rod-Like Liquid Crystalline Molecule)

Preferred examples of the rod-like liquid crystalline molecule include azomethines, azoxys, cyanobiphenyls, cyanophenyl esters, benzoic esters, phenyl cyclohexane-carboxylates, cyanophenylcyclohexanes, cyano-substituted phenylpyridines, alkoxy-substituted phenylpyrimidines, phenyldioxanes, tolanes and alkenylcyclohexylbenzonitriles.

The rod-like liquid crystalline molecule also includes metal complexes. A liquid crystal polymer containing a rod-like liquid crystalline molecule in the repeating unit can also be used as the rod-like liquid crystalline molecule. In other words, the rod-like liquid crystalline molecule may be bonded to a (liquid crystal) polymer.

The rod-like liquid crystalline molecule is described in “Ekisho no Kagaku”, Kikan Kagaku Sosetsu (“Chemistry of Liquid Crystal”, Quarterly Chemical Review), Vol. 22, Chap. 4, Chap. 7 and Chap. 11, compiled by Nippon Kagaku Kai (1994); and Ekisho Device Handbook (Liquid Crystal Device Handbook), Chap. 3, complied by Nippon Gakujutsu Shinko Kai, Committee No. 142.

The birefringent index of the rod-like liquid crystalline molecule is preferably from 0.001 to 0.7.

The rod-like liquid crystalline molecule preferably has a polymerizable group so as to fix the rod-like liquid crystalline molecule in the alignment state thereof. The polymerizable group is preferably a radical polymerizable unsaturated group or a cationic polymerizable group, and specific examples thereof include the polymerizable group and polymerizable liquid crystal compounds described in JP-A-2002-62427, paragraphs (0064) to (0086).

### (Discotic Liquid Crystalline Molecule)

Examples of the discotic liquid crystalline molecule include benzene derivatives described in a study report of C. Destrade et al., Mol. Cryst., Vol. 71, page 111 (1981); truxene derivatives described in a study report of C. Destrade et al., Mol. Cryst., Vol. 122, page 141 (1985), and Phyics. Lett., A, Vol. 78, page 82 (1990); cyclohexane derivatives described in a study report of B. Kohne et al., Angew. Chem., Vol. 96, page 70 (1984); macrocycles of azacrown type and phenylacetylene type described in a study report of J. M. Lehn et al., J. Chem. Commun., page 1794 (1985), and a study report of J. Zhang et al., J. Am. Chem. Soc., Vol. 116, page 2655 (1994).

The discotic liquid crystalline molecule includes a compound exhibiting liquid crystallinity and having a structure such that a linear alkyl group, an alkoxyl group or a substituted benzoyloxy group is radially substituted as a side chain to a-mother nucleus in the molecular center. The discotic liquid crystal is preferably a compound where a molecule or an agglomerate of molecules has a rotation symmetry and can be imparted with a certain orientation. In the optically anisotropic layer formed from discotic liquid crystalline molecules, the compound contained in the optically anisotropic layer need not be finally a discotic liquid crystalline molecule. For example, the compound also includes a compound in which a low molecular discotic liquid crystalline molecule has a group capable of reacting under the action of heat or light and which is polymerized or crosslinked to have a high molecular weight through a reaction under the action of heat or light, as a result, deprived of the liquid crystallinity. Preferred examples of the discotic liquid crystalline molecule include those described in JP-A-8-50206. The polymerization of the discotic liquid crystalline molecule is described in JP-A-8-27284.

In order to fix the discotic liquid crystalline molecules by polymerization, a polymerizable group must be bonded as a substituent to the discotic core of the discotic liquid crystalline molecule. A compound of allowing for bonding of the polymerizable group to the discotic core through a linking group is preferred and by such bonding, the alignment state can be maintained even at the polymerization reaction. Examples thereof include the compounds described in JP-A-2000-155216, paragraphs (0151) to (0168).

In the hybrid alignment, the angle between the long axis (disc plane) of the discotic liquid crystalline molecule and the plane of the polarizing layer is increased or decreased as the distance from the plane of the polarizing layer in the depth direction of the optically anisotropic layer increases. The angle is preferably increased as the distance increases. The change of angle may be a continuous increase, a continuous decrease, an intermittent increase, an intermittent decrease, a change containing continuous increase and continuous decrease, or an intermittent change containing increase and decrease. In the intermittent change, a region where the tilt angle is not changed is present on the way in the thickness direction. Even when a region having no change of angle is present, it may suffice if the angle is increased or decreased as a whole. The angle is preferably changed continuously.

The average direction of the long axis of the discotic liquid crystalline molecules on the polarizing layer side can be adjusted generally by selecting the material for the discotic liquid crystalline molecule or alignment film or by selecting the rubbing method. Also, the long axis (disc plane) direction of the discotic liquid crystalline molecule on the surface side (air side) can be adjusted generally by selecting the kind of the discotic liquid crystalline molecule or additive used together with the discotic liquid crystalline molecule. Examples of the additive used together with the discotic liquid crystalline molecule include a plasticizer, a surfactant, a polymerizable monomer and a polymer. The degree of change in the orientation direction of the long axis can be adjusted similarly to the above by selecting the liquid crystalline molecule or additive.

### (Other Components of Optically Anisotropic Layer)

For example, a plasticizer, a surfactant and a polymerizable monomer may be used together with the discotic liquid crystalline molecule to enhance the uniformity of the coating film, the film strength, the alignment property of liquid crystalline molecules, or the like. These additives are preferably a compound having compatibility with the discotic liquid crystalline molecule and capable of giving change in the tilt angle of the liquid crystalline molecule or not inhibiting the alignment.

The polymerizable monomer includes radical polymerizable or cationic polymerizable compounds. A polyfunctional radical polymerizable monomer is preferred, and a compound copolymerizable with the above-described polymerizable group-containing liquid crystal compound is preferred. Examples thereof include those described in JP-A-2002-296423, paragraphs (0018) to (0020). The amount of this compound added is generally from 1 to 50 weight %, preferably from 5 to 30 weight %, based on the discotic liquid crystalline molecule.

The surfactant includes conventionally known compounds, but a fluorine-based compound is preferred. Examples thereof include those described in JP-A-2001-330725, paragraphs (0028) to (0056).

The polymer used together with the discotic liquid crystalline molecule is preferably a compound capable of giving change in the tilt angle of the discotic liquid crystalline molecule.

Examples of the polymer include cellulose esters. Preferred examples of the cellulose ester include those described in JP-A-2000-155216, paragraph (0178). In order not to inhibit the alignment of liquid crystalline molecules, the amount of the polymer added is preferably from 0.1 to 10 weight %, more preferably from 0.1 to 8 weight %, based on the liquid crystalline molecule.

The discotic nematic liquid crystal phase-solid phase transition temperature of the discotic liquid crystalline molecule is preferably from 70 to 300° C., more preferably from 70 to 170° C.

### (Formation of Optically Anisotropic Layer)

The optically anisotropic layer can be formed by applying a coating solution containing the liquid crystalline molecule and if desired, containing a polymerization initiator described below and other arbitrary components onto the alignment film.

The solvent used for the preparation of the coating solution is preferably an organic solvent. Examples of the organic solvent include amides (e.g., N,N-dimethylformamide), sulfoxides (e.g., dimethylsulfoxide), heterocyclic compounds (e.g., pyridine), hydrocarbons (e.g., benzene, hexane), alkyl halides (e.g., chloroform, dichloromethane, tetrachloroethane), esters (e.g., methyl acetate, butyl acetate), ketones (e.g., acetone, methyl ethyl ketone) and ethers (e.g., tetrahydrofuran, 1,2-dimethoxyethane). Among these, alkyl halides and ketones are preferred. Two or more organic solvents may be used in combination.

The coating solution can be applied by a known method (e.g., wire bar coating, extrusion coating, direct gravure coating, reverse gravure coating, die coating).

The thickness of the optically anisotropic layer is preferably from 0.1 to 20 μm, more preferably from 0.5 to 15 μm, and most preferably from 1 to 10 μm.

### (Fixing of Liquid Crystalline Molecules in Alignment State)

The aligned liquid crystalline molecules are fixed while keeping the alignment state. The fixing is preferably performed by a polymerization reaction. The polymerization reaction includes a thermal polymerization reaction using a thermal polymerization initiator, and a photopolymerization reaction using a photopolymerization initiator. Of these, a photopolymerization reaction is preferred.

Examples of the photopolymerization initiator include α-carbonyl compounds (described in U.S. Pat. Nos. 2,367,661 and 2,367,670), acyloin ethers (described in U.S. Pat. No. 2,448,828), α-hydrocarbon-substituted aromatic acyloin compounds (described in U.S. Pat. No. 2,722,512), polynuclear quinone compounds (described in U.S. Pat. Nos. 3,046,127 and 2,951,758), combinations of triarylimidazole dimer and p-aminophenyl ketone (described in U.S. Pat. No. 3,549,367), acridine and phenazine compounds (described in JP-A-60-105667 and U.S. Pat. No. 4,239,850) and oxadiazole compounds (described in U.S. Pat. No. 4,212,970).

The amount of the photopolymerization initiator used is preferably from 0.01 to 20 weight %, more preferably from 0.5 to 5 weight %, based on the solid content of the coating solution.

The light irradiation for the polymerization of liquid crystalline molecules is preferably performed by using an ultraviolet ray.

The irradiation energy is preferably from 20 mJ/cm² to 50 J/cm², more preferably from 20 to 5,000 mJ/cm², still more preferably from 100 to 800 mJ/cm². In order to accelerate the photopolymerization reaction, the light irradiation may be performed under heating.

Reducing a concentration of oxygen inhibiting the polymerization is preferred is preferred. For example, the light irradiation may be performed under nitrogen-purge. During the UV irradiation, the oxygen concentration in an atmosphere is preferably less than 10%, more preferably less than 5%. It is possible to relatively reduce the oxygen exposure amount by pressure reduction.

Also, a protective layer may be provided on the optically anisotropic layer.

In the optical compensatory sheet of the present invention, the surface of the optical compensatory sheet is subjected to a hydrophilization treatment. More specifically, the face of the optical compensatory sheet coming into contact with the polarizing layer is hydrophilized so as to enhance the adhesion with the polarizing layer when the optical compensatory sheet is laminated on the polarizing layer and used as a protective film of the polarizing plate. In the case of providing an adhesive layer on the face opposite to the face of the optical compensatory film coming into the polarizing layer, this face is sometimes preferably hydrophilized. Examples of the hydrophilization treatment include, similarly to the surface treatment of the above-described polymer film, a corona discharge treatment, a glow discharge treatment, a flame treatment, an acid treatment, an alkali treatment and an ultraviolet irradiation treatment. Among these, an alkali saponification treatment is preferred, and a method of dipping the optical compensatory sheet in a saponification solution is more preferred in view of the production of a polarizing plate. Therefore, the optical compensatory sheet of the present invention is hydrophilized by dipping the optical compensatory sheet in an alkali bath and saponifying both surfaces of the optical compensatory sheet. At this time, the hydrophilization treatment is performed such that the thicknesses of the optically anisotropic layer constituting the optical compensatory sheet, before and after the hydrophilization treatment, satisfy the following formula (I):

(DB−DA)/DB<0.01

wherein DA represents a thickness of the optically anisotropic layer after the hydrophilization treatment and DB represents a thickness of the optically anisotropic layer before the hydrophilization treatment. By performing the hydrophilization treatment to satisfy formula (I) and controlling the treated amount to a such degree that the optical characteristics of the optical compensatory sheet can be regarded as being not changed in practice by the hydrophilization treatment, designed optical characteristics can be realized and an optical compensatory sheet capable of high-level compensation of the viewing angle can be obtained.

In order to realize good adhesion, the water contact angle on the surface of the optical compensatory sheet is preferably small and specifically, when the contact angle is from 20° to less than 50°, good adhesion free from separation can be obtained. With a contact angle of 20° to less than 40°, more preferred results can be obtained. The progress of hydrophilization on the surface can be more exactly analyzed by using electron spectroscopy or the like and when observed by such a method, the abundance ratio of the carbon-oxygen single bond on the surface of the optical compensatory sheet after the hydrophilization treatment must be larger than that before the hydrophilization treatment.

By performing the hydrophilization treatment to satisfy these conditions, an optical compensatory film having excellent adhesion to the polarizing layer and having high reliability can be obtained.

### (Polarizing Layer)

The optical compensatory sheet of the present invention remarkably exerts its function when used as a protective film of an elliptically polarizing plate (or polarizing plate). More specifically, a thin polarizing plate reduced in the stress (strain×cross-sectional area×elastic modulus) according to dimensional change of a polarizing layer can be prepared and therefore, when the elliptically polarizing plate according to the present invention is fixed in a large liquid crystal display device, a high-grade image can be displayed without causing a trouble such as light leakage.

The polarizing layer is preferably a coating-type polarizing layer as represented by those produced by Optiva Inc., or a polarizing layer comprising a binder and iodine or a dichroic dye.

The iodine or dichroic dye in the polarizing layer is oriented in the binder and thereby exerts its polarizing performance. The iodine or dichroic dye is preferably oriented along the binder molecule or the dichroic dye is preferably oriented in one direction by undergoing self-organization like liquid crystal.

At present, commercially available polarizing layer are generally produced by dipping a stretched polymer in a bath containing a solution of iodine or dichroic dye, and allowing the iodine or dichroic dye to penetrate into the binder.

In the commercially available polarizing layer, iodine or dichroic dye is distributed in the region of about 4 μm from the polymer surface (about 8 μm in total of both sides) and for obtaining a satisfactory polarizing performance, a thickness of at least 10 μm is necessary. The degree of penetration can be controlled by the concentration of iodine or dichroic dye solution, the temperature of bath containing the solution, and the dipping time in the solution.

As described above, the lower limit of the binder thickness is preferably 10 μm. As for the upper limit of the thickness, a smaller thickness is more preferred in view of light leakage of the liquid crystal display device. The upper limit is preferably lower than that (about 30 μm) of the polarizing plate available at present on the market and is preferably 25 μm or less, more preferably 20 μm or less.

The binder of the polarizing layer may be crosslinked.

For the crosslinked binder, a self-crosslinkable polymer may be used. A polymer having a functional group or a binder obtained by introducing a functional group into a polymer is exposed to light or heat or changed in the pH to cause a reaction between binders, whereby a polarizing layer can be formed.

Also, a crosslinked structure may be introduced into the polymer by a crosslinking agent.

The crosslinking is generally performed by applying a coating solution containing a polymer or a mixture of a polymer and a crosslinking agent onto a transparent support and then heating it. It may suffice if durability can be ensured at the stage of a final commercial product, therefore, the treatment for crosslinking may be performed at any stage until a final elliptically polarizing plate (or polarizing plate) is obtained.

The binder of the polarizing layer may be either a self-crosslinkable polymer or a polymer which is crosslinked by a crosslinking agent. Examples of the polymer are the same as those described above regarding the polymer for the alignment film.

Polyvinyl alcohols and modified polyvinyl alcohols are most preferred.

The modified polyvinyl alcohol is described in JP-A-8-338913, JP-A-9-152509 and JP-A-9-316127.

The polyvinyl alcohols and modified polyvinyl alcohols may be used in combination of two or more thereof.

The amount added of the crosslinking agent of the binder is preferably from 0.1 to 20 weight % based on the binder. Within this range, the alignment property of the elliptically polarizing plate (or polarizing plate) and the humidity/heat resistance of the polarizing layer are enhanced.

Even after the completion of crosslinking reaction, the alignment film somewhat contains an unreacted crosslinking agent. The amount of the crosslinking agent remaining in the alignment film is preferably 1.0 weight % or less, more preferably 0.5 weight % or less. Within this range, decrease in the polarization degree does not occur even when the polarizing layer is integrated in a liquid crystal display device and used for a long time or is left standing in a high-temperature high-humidity atmosphere for a long time.

The crosslinking agent is described in U.S. Pat. No. RE23,297. A boron compound (e.g., boric acid, borax) may also be used as the crosslinking agent.

As for the dichroic dye, an azo-based dye, a stilbene dye, a pyrazolone dye, a triphenylmethane dye, a quinoline dye, an oxazine dye, a thiadine dye or an anthraquinone dye is used. The dichroic dye is preferably water-soluble. Also, the dichroic dye preferably has a hydrophilic substituent (e.g., sulfo, amino, hydroxyl).

Examples of the dichroic dye include the compounds described in JIII Journal of Technical Disclosure, No. 2001-1745, page 58 (Mar. 15, 2001).

In order to increase the contrast ratio of a liquid crystal display device, the transmittance of the elliptically polarizing plate (or polarizing plate) is preferably higher and the polarization degree is also preferably higher. The transmittance of the elliptically polarizing plate (or polarizing plate) is preferably from 30 to 50%, more preferably from 35 to 50%, and most preferably from 40 to 50%, for light at a wavelength of 550 nm. The polarization degree is preferably from 90 to 100%, more preferably from 95 to 100%, and most preferably from 99 to 100%, for light at a wavelength of 550 nm.

The polarizing layer and the optically anisotropic layer, or the polarizing layer and the alignment film may be provided through an adhesive. As for the adhesive, a polyvinyl alcohol-based resin (including a polyvinyl alcohol modified with an acetoacetyl group, a sulfonic acid group, a carboxyl group or an oxyalkylene group) and an aqueous boron compound solution can be used. Of these, a polyvinyl alcohol-based resin is preferred. The thickness of the adhesive layer after drying is preferably from 0.01 to 10 μm, more preferably from 0.05 to 5 μm.

### EXAMPLES

The present invention is described in greater detail below by referring to Examples. The material, reagent, amount and ratio of material, operation and the like used in the following Examples can be appropriately changed without departing from the purport of the present invention. Accordingly, the scope of the present invention is not limited to the following specific examples.

### Example 1

An optical compensatory sheet and an elliptically polarizing plate each having a constitution shown in FIG. 1 were produced.

### <Production of Cellulose Acetate Film>

The following composition was charged into a mixing tank and respective components were dissolved by stirring under heating to prepare a cellulose acetate solution.

(Composition of Cellulose Acetate Solution)

| | | |
|---|---|---|
| Cellulose acetate having an acetylation degree of | 100 | parts by weight |
| 60.7 to 61.1% | | |
| Triphenyl phosphate (plasticizer) | 7.8 | parts by weight |
| Biphenyl diphenyl phosphate (plasticizer) | 3.9 | parts by weight |
| Methylene chloride (first solvent) | 336 | parts by weight |
| Methanol (second solvent) | 29 | parts by weight |
| 1-Butanol (third solvent) | 11 | parts by weight |

In a separate mixing tank, 16 parts by weight of a retardation increasing agent shown below, 92 parts by weight of methylene chloride and 8 parts by weight of methanol were charged and stirred under heating to prepare a retardation increasing agent solution. Then, 25 parts by weight of the retardation increasing solution was mixed to 474 parts by weight of the cellulose acetate solution and thoroughly stirred to prepare a dope. The amount of the retardation increasing agent added was 6.0 parts by weight per 100 parts by weight of cellulose acetate.

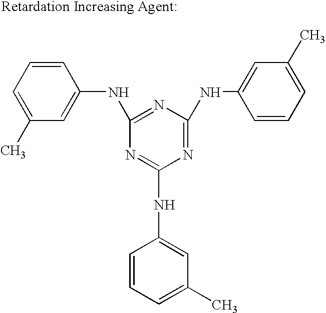

The obtained dope was cast by using a band casting machine. After the film surface temperature on the band reached 40° C., the film was dried with hot air at 70° C. for 1 minute, stripped off from the band and dried with dry air at 140° C. for 10 minutes to produce a cellulose acetate film having a residual solvent amount of 0.3 weight % (thickness: 80 μm). The produced cellulose acetate film (transparent support, transparent protective film) was measured on the Re retardation value and Rth retardation value at a wavelength of 546 nm by using an ellipsometer (M-150, manufactured by JASCO Corporation). Re was 8 nm and Rth was 78 nm.

<Production of Alignment film for Optically Anisotropic Layer>

On this cellulose acetate film, a coating solution having the following composition was coated to a coverage of 28 ml/m² by a #16 wire bar coater and then dried with hot water at 60° C. for 60 seconds and further with hot water at 90° C. for 150 seconds. Then, the film formed was rubbed in the direction of 10° with respect to the in-plane slow axis (direction in parallel to the casting direction) of the cellulose acetate film.

Composition of Coating Solution for Alignment film:

| | | |
|---|---|---|
| Modified polyvinyl alcohol shown below | 20 | parts by weight |
| Water | 360 | parts by weight |
| Methanol | 120 | parts by weight |
| Glutaraldehyde (crosslinking agent) | 1.0 | part by weight |

Modified Polyvinyl Alcohol:

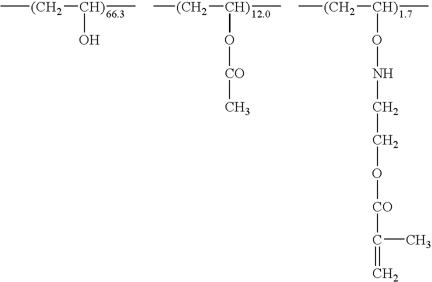

### <Production of Optically Anisotropic Layer>

A coating solution prepared by dissolving 91.0 g of a discotic (liquid crystalline) compound shown below, 9.0 g of ethylene oxide-modified trimethylolpropane triacrylate (V#360, produced by Osaka Organic Chemical Industry Ltd.), 2.0 g of cellulose acetate butyrate (CAB551-0.2, produced by Eastman Chemical), 0.5 g of cellulose acetate butyrate (CAB531-1, produced by Eastman Chemical), 3.0 g of photopolymerizatibn initiator (Irgacure 907, produced by Ciba-Geigy) and 1.0 g of sensitizer (Kayacure DETX, produced by Nippon Kayaku Co., Ltd.) in 207 g of methyl ethyl ketone was coated on the alignment film to a coverage of 6.2 ml/m² by a #3.6 wire bar and then heated in a constant temperature zone at 130° C. for 2 minutes, thereby aligning the discotic compound. Thereafter, UV light was irradiated in a 60° C. atmosphere for 1 minute by using a metal halide lamp with an output of 120 W/cm to polymerize the discotic compound and then the film was allowed to cool to room temperature. In this way, an optically anisotropic layer was formed and an optical compensatory sheet was produced.

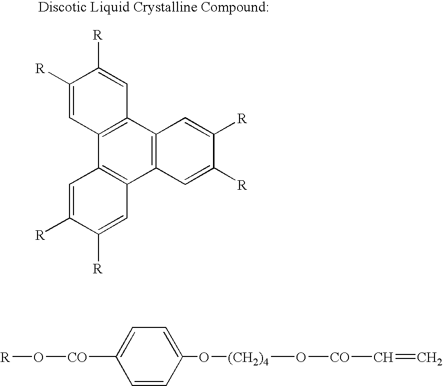

In the optically anisotropic layer formed, the discotic liquid crystalline compound was being hybrid-aligned at 11° to 66°, where the angle (tilt angle) between the disc plane and the transparent protective film (the produced cellulose acetate film) was increasing from the transparent protective film toward the air interface. The optically anisotropic layer was a uniform film free of defects such as schlieren. The retardation was measured by using an ellipsometer (M-150, manufactured by JASCO Corporation) while changing the observation angle and by using virtual modeling of a refractive index ellipsoid, the tilt angle was calculated according to the method described in Designing concepts of the Discotic Negative Birefringence Compensation Films SID98 DIGEST.

### <Production of Elliptically Polarizing Plate>

The optical compensatory sheet produced was dipped in an aqueous 1.5N NaOH solution at 50° C. for 1.5 minutes to hydrophilize the surface, then neutralized with sulfuric acid, washed with pure water and dried. A 80 μm-thick cellulose triacetate film (TD-80U, produced by Fuji Photo Film Co., Ltd.) was also hydrophilized in the same manner. After producing polarizing layer by adsorbing iodine to a stretched polyvinyl alcohol film, the hydrophilized optical compensatory sheet and cellulose triacetate film were stacked on both surfaces of the polarizing layer by using a polyvinyl alcohol-based adhesive. At this time, the face of the optical compensatory sheet, where the optically anisotropic layer was not coated, was stacked with the polarizing layer. Also, the absorption axis of the polarizing film and the slow axis (direction in parallel to the casting direction) of the transparent support (the produced cellulose acetate film) of the optical compensatory sheet were disposed to run in parallel. In this way, a polarizing plate was produced.

Before and after the hydrophilization treatment, the optical compensatory sheet was subjected to the following measurements. The results are shown in Table 1.

### <Measurement of Thickness of Optically Anisotropic Layer>

The thickness of the optically anisotropic layer was measured by a light interference method before and after the hydrophilization treatment. The film thickness (DB) before hydrophilization was 1.61 μm, whereas the film thickness (DA) after hydrophilization was 1.60 μm. From these, the value of (DB−DA)/DB was 0.006.

### <Measurement of Contact Angle>

The water contact angle on the face of the optical compensatory sheet after hydrophilization, to be stacked with the polarizing layer (that is, the face on the side where the optically anisotropic layer was not coated), was measured. The contact angle was 64° before hydrophilization and 32° after hydrophilization.

### <Surface Analysis>

The face of the optical compensatory sheet after hydrophilization, to be stacled with the polarizing layer (that is, the face on the side where the optically anisotropic layer was not coated), was measured by ESCA. The intensities of carbon and oxygen as main constituent elements of the film were measured and the peak intensity ratio (C═O/C—O) between the carbon-oxygen single bond and carbon-oxygen double bond was compared, as a result, the ratio was 0.58 before hydrophilization and 0.28 after hydrophilization. Also, the peak intensity ratio (C—C/C—O) between carbon-carbon single bond and carbon-oxygen double bond was compared, as a result, the ratio was 0.8 before hydrophilization and 0.4 after hydrophilization. From these, it was apparent that the carbon-oxygen single bond was increased.

### <Production of Liquid Crystal Cell>

In the liquid crystal cell, the cell gap (d) was set to 5 μm and a liquid crystalline material having a positive dielectric anisotropic layer was dropwise injected between substrates and encapsulated to give Δnd of 420 nm (Δn is refractive index anisotropy of the liquid crystal material). The twist angle of the liquid crystal layer in the liquid crystal cell was set to 90°.

As shown in FIG. 2, the liquid crystal display device was produced. The liquid crystal display device includes a backlight 08, the produced elliptically polarizing plate 09, the produced liquid crystal cell 06 containing the liquid crystal layer 07 and the produced elliptically polarizing plate 09 in this order. The produced elliptically polarizing plate 09 was stacked on the top and bottom of the liquid crystal cell 06 through an adhesive such that the absorption axis 11 of the produced elliptically polarizing plate 09 (upper plate) was agreeing with the rubbing direction 12 of the top substrates of the liquid crystal cell 06, and that the absorption axis 14 of the produced elliptically polarizing plate 09 (lower plate) was agreeing with the rubbing direction 13 of the top substrates of the liquid crystal cell 06.

### <Optical Measurement (Measurement of Viewing Angle) of Liquid Crystal Display Device Produced>

A rectangular wave voltage of 60 Hz was applied to the thus-produced liquid crystal display device. The mode was set to a normally white mode with white display of 1.5 V and black display of 5.6 V. By using a measuring meter (EZ-Contrast 160D, manufactured by ELDIM), the contrast ratio which is the transmittance ratio (white display/black display), and the transmittance and viewing angle in 8 gradations from black display (L1) to white display (L8) transmittance divided at equal intervals were measured. The range having no inversion of the transmittance between adjacent gradations in the lower direction, that is, the range having a contrast ratio of 10 or more, was measured. The results are shown in Table 1.

### <Evaluation of Durability>

The produced elliptically polarizing plate was left standing in an atmosphere of 60° C. and 90% RH for 1,000 hours and thereafter, the presence or absence of separation between the polarizing layer and the optical compensatory sheet was inspected. The results are shown in Table 1.

### Example 2

An optical compensatory sheet, an elliptically polarizing plate and a liquid crystal display device were produced, measured and evaluated in the same manner as in Example 1 except that the UV irradiation at the production of the optically anisotropic layer was performed in an nitrogen atmosphere (an oxygen concentration of 2%) at 60° C.

### Comparative Example 1

An optical compensatory sheet, an elliptically polarizing plate and a liquid crystal display device were produced, measured and evaluated in the same manner as in Example 1 except that in the production of the optically anisotropic layer, the coating solution was prepared by dissolving 91.0 g of the discotic (liquid crystalline) compound shown above, 9.0 g of ethylene oxide-modified trimethylolpropane triacrylate (V#360, produced by Osaka Organic Chemical Industry Ltd.), 2.0 g of cellulose acetate butyrate (CAB551-0.2, produced by Eastman Chemical), 0.5 g of cellulose acetate butyrate (CAB531-1, produced by Eastman Chemical) and 2.0 g of photopolymerization initiator (Irgacure 907, produced by Ciba-Geigy) in 207 g of methyl ethyl ketone. The results are shown in Table 1.

### Comparative Example 2

An optical compensatory sheet, an elliptically polarizing plate and a liquid crystal display device were produced, measured and evaluated in the same manner as in Example 1 except that in the production of the polarizing plate, the optical compensatory sheet was dipped in an aqueous 2N NaOH solution at 60° C. for 2 minutes to hydrophilize the surface. The results are shown in Table 1.

### Comparative Example 3

An optical compensatory sheet, an elliptically polarizing plate and a liquid crystal display device were produced, measured and evaluated in the same manner as in Example 1 except that in the production of the polarizing plate, the optical compensatory sheet was dipped in an aqueous 1.5N NaOH solution at 40° C. for 2 minutes to hydrophilize the surface. The results are shown in Table 1.

TABLE 1

| | Thickness | | | | Viewing Angle | | | |
|---|---|---|---|---|---|---|---|---|
| | of Optically | | | | of Liquid Crystal | | | |
| | Anisotropic Layer | | | | Display Device | | | Durability |
| | Before | After | | Contact | | | Inversion in | Separation due |
| | Hydro- | Hydro- | (DB − DA)/ | Angle | | | Lower | to Humidity |
| Sample | philization | philization | DB | (water) | Up/Down | Right/Left | Direction | and Heat |
| Example 1 | 1.61 | 1.60 | 0.006 | 32° | 152° | 160° | 50° | none |
| Example 2 | 1.61 | 1.61 | 0.000 | 33° | 151° | 162° | 51° | none |
| Comparative | 1.58 | 1.55 | 0.019 | 33° | 148° | 155° | 48° | none |
| Example 1 | | | | | | | | |
| Comparative | 1.61 | 1.57 | 0.025 | 28° | 123° | 154° | 45° | none |
| Example 2 | | | | | | | | |
| Comparative | 1.61 | 1.61 | 0.000 | 53° | 151° | 162° | 51° | separated |
| Example 3 | | | | | | | | |

The results shown in Table 1 reveal the followings.

In Examples (present invention), good results are obtained in the viewing angle of the liquid crystal display device and the durability is also excellent. In Comparative Examples 1 and 2, the thickness of the optically anisotropic layer is changed at the hydrophilization treatment to an extent that (DB−DA)/DB exceeds 0.01, and therefore, when a liquid crystal display is produced, poor viewing angle characteristics result. In Comparative Example 3, the thickness of the optically anisotropic layer is not changed and good viewing angle is obtained, but the film is separated in aging under humidity and heat and the durability has a problem.

The present application claims foreign priority based on Japanese Patent Application No. JP2004-54394 filed Feb. 27 of 2004, the contents of which is incorporated herein by reference.

What is claimed is:

1. A method for producing an optical compensatory sheet, which comprises:
coating a layer comprising a liquid crystalline molecule on a transparent support;
aligning the liquid crystalline molecule in an alignment state;
fixing the liquid crystalline molecule in the alignment state to form an optically anisotropic layer; and
performing a hydrophilization treatment of a surface of the optical compensatory sheet,
wherein the hydrophilization treatment is performed under a condition that the optically anisotropic layer satisfies formula (I):
(DB−DA)/DB<0.01
wherein DA represents a thickness of the optically anisotropic layer after the hydrophilization treatment; and DB represents a thickness of the optically anisotropic layer before the hydrophilization treatment.

2. The method for producing the optical compensatory sheet according to claim 1, wherein the hydrophilization treatment is an alkali saponification treatment.

3. The method for producing the optical compensatory sheet according to claim 1, wherein the surface of the optical compensatory sheet has a water contact angle of 20° to less than 50° after the hydrophilization treatment.

4. The method for producing the optical compensatory sheet according to claim 1, wherein the surface of the optical compensatory sheet has an abundance ratio of a carbon-oxygen single bond after the hydrophilization treatment, and the abundance ratio is larger than that before the hydrophilization treatment.

5. A method for producing an elliptically polarizing plate, which comprises stacking an optical compensatory sheet, a polarizing layer of transmitting a light polarized in one direction with respect to an incident light, and a transparent protective sheet in this order,
wherein the optical compensatory sheet is produced by a method comprising:
coating a layer comprising a liquid crystalline molecule on a transparent support;
aligning the liquid crystalline molecule in an alignment state;
fixing the liquid crystalline molecule in the alignment state to form the optically anisotropic layer; and
performing a hydrophilization treatment of a surface of the optical compensatory sheet,
wherein the hydrophilization treatment is performed under a condition that the optically anisotropic layer satisfies formula (I):
(DB−DA)/DB<0.01
wherein DA represents a thickness of the optically anisotropic layer after the hydrophilization treatment; and DB represents a thickness of the optically anisotropic layer before the hydrophilization treatment.

6. The method for producing the elliptically polarizing plate according to claim 5, wherein the hydrophilization treatment is an alkali saponification treatment.

7. The method for producing the elliptically polarizing plate according to claim 5, wherein the surface of the optical compensatory sheet has a water contact angle of 20° to less than 50° after the hydrophilization treatment.

8. The method for producing the elliptically polarizing plate according to claim 5, wherein the surface of the optical compensatory sheet has an abundance ratio of a carbon-oxygen single bond after the hydrophilization treatment, and the abundance ratio is larger than that before the hydrophilization treatment

9. The method for producing the optical compensatory sheet according to claim 1, wherein the hydrophilization treatment is performed for a time period of less than 2 minutes.

10. The method for producing the optical compensatory sheet according to claim 9, wherein the optically anisotropic layer is formed in a nitrogen atmosphere.

11. The method for producing the elliptically polarizing plate according to claim 5, wherein the hydrophilization treatment is performed for a time period of less than 2 minutes.

12. The method for producing the elliptically polarizing plate according to claim 11, wherein the optically anisotropic layer is formed in a nitrogen atmosphere.
